(19) United States
(12) Patent Application Publication
(10) Pub. No.: US 2026/0245032 A1
(43) Pub. Date: Aug. 20, 2026

(54) A METHOD FOR PREDICTING THE TURN TIME OF A CONTAINER AND RELATED ELECTRONIC DEVICE

(71) Applicant: MAERSK A/S, Copenhagen K (DK)

(72) Inventors: Alok BHARDWAJ, Copenhagen K (DK); Satyam Sitaram SINGH, Airoli (IN); Sachin Dadasaheb CHAUDHARI, Bengaluru (IN); Sunil Kumar CHINNAMGARI, Bengaluru (IN); Uday Kumar PAPICHETTY, Bengaluru (IN); Rakesh Nagaraj AMMAN, Bengaluru (IN)

(21) Appl. No.: 19/161,021

(22) PCT Filed: Feb. 20, 2024
(86) PCT No.: PCT/DK2024/050030

§ 371 Date: Aug. 29, 2025

(30) Foreign Application Priority Data
Mar. 3, 2023 (DK) PA202370117

(51) Int. Cl. G06Q 10/083

(52) U.S. Cl. CPC G06Q 10/0843

(57) ABSTRACT

Disclosed is a method, performed by an electronic device, for predicting the turn time of a container. The method comprises obtaining shipment data associated with a shipment of one or more containers. The method comprises generating, based on the shipment data, a turn time parameter indicative of a turn time of the container by applying a prediction model to the shipment data. The method comprises providing an output based on the turn time parameter.

The present disclosure pertains to the field of transport and freight. The present disclosure relates to a method for predicting the turn time of a container and related electronic device.

### BACKGROUND

Shipping of containers involves arrival and/or subsequent departure of a container at a port. During shipping, many actions relating to a container are carried out, e.g., unloading and loading of the container on a vessel and/or other transportation means, searching of the container, and/or obtention of documentation associated with the container. Time taken for the various operations to be carried out may vary greatly and depends on many variables.

### SUMMARY

The time period between the time that the container arrives at a terminal to be discharged off the vessel and the time that the container returns to the terminal (e.g. after the container has been emptied of items destined to a recipient) may be seen as a turn time. The turn time can be affected by many factors. There is a need for an electronic device and a method that can provide a prediction of the turn time of a container. (e.g., the turn time of a container at a port)

Accordingly, there is a need for an electronic device and a method for predicting the turn time of a container, which mitigate, alleviate, or address the shortcomings existing and may allow for a more accurate, robust, and time-efficient prediction of the turn time of a container.

Disclosed is a method, performed by an electronic device, for predicting the turn time of a container. The method comprises obtaining shipment data associated with a shipment of one or more containers. The method comprises generating, based on the shipment data, a turn time parameter indicative of a turn time of the container by applying a prediction model to the shipment data. The method comprises providing an output based on the turn time parameter.

Disclosed is an electronic device comprising memory circuitry, processor circuitry, and an interface, wherein the electronic device is configured to perform any of the methods according to the methods disclosed herein.

Disclosed is a computer readable storage medium storing one or more programs, the one or more programs comprising instructions, which when executed by an electronic device with a display and a touch-sensitive surface cause the electronic device to perform any of the methods disclosed herein.

It is an advantage of the present disclosure that the disclosed electronic device and method provide more accurate, robust, and time-efficient prediction of the turn time of a container. This may result in providing more efficiency across various operations. For examples, a consignee may be provided with a turn time estimate that has accounted for returning empty container back to the terminal and reduces the risk of unforeseen operations (such as unforeseen extra time for e.g. Demurrage and Detention, and/or associated costs). This may lead to an improved container resource management, which may result in a successful shipment, and thereby may reduce the number of complaints.

### BRIEF DESCRIPTION OF THE DRAWINGS

The above and other features and advantages of the present disclosure will become readily apparent to those skilled in the art by the following detailed description of exemplary embodiments thereof with reference to the attached drawings, in which:

FIGS. 1A-B is a flow-chart illustrating an exemplary method, performed by an electronic device, for predicting a turn time of a container according to this disclosure,

FIG. 2 is a block diagram illustrating an exemplary electronic device according to this disclosure, and

FIGS. 3A-C are example representations of example outputs of the disclosed technique.

### DETAILED DESCRIPTION

Various exemplary embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

The figures are schematic and simplified for clarity, and they merely show details which aid understanding the disclosure, while other details have been left out. Throughout, the same reference numerals are used for identical or corresponding parts.

In the import side journey of a container, a consignee is a party that takes a filled container and returns an empty container. A consignee may be seen as the receiver of the shipped container. In other words, the consignee may be seen as a party responsible for accepting the delivery of the commodity (e.g., items) in the container. A consignor may be seen as the transporter (e.g., carrier) of the container. For example, the consignor may transport containers (e.g., comprising commodities) on behalf of a consignee.

A consignee can select a time extension (such as a free time extension) at the time of booking a shipping of a container to allow more time for loading and/or unloading of the container. This helps a consignee and/or consignor to mitigate the risk of costly operations, such as Demurrage and Detention (D&D) applicable when the consignee holds carrier equipment in the terminal for longer than the agreed amount of time. However, the consignee is not able to mitigate the risk of unforeseen extension of times e.g. for D&D. This leads a lack of efficiency in the operations, and lack of visibility and/or robustness of the operations and services. This may lead to disputes, revenue leakages, and eventually dissatisfaction of the consignee.

The present disclosure proposes, inter alia, to predict the turn time of a container so that a time extension can be allocated and selected by the consignee when booking a shipping of the container. This may reduce the risk of unforeseen operations, associated time and costs.

A turn time may be seen as a time period from which a loaded container (e.g., a container comprising items) arrives at the port, to the time an unloaded container (e.g., a container not comprising items, e.g., an empty container and/or partly empty container) is returned to the port. For example, the time period between the time that the container arrives at a terminal to be discharged off the vessel and the time that the container returns to the terminal (e.g. after the container has been emptied of items destined to a recipient) may be seen as a turn time. In some examples, the turn time includes the detention time solely. For example, the turn time can be seen as the time period between that the container leaves the terminal to be delivered to the recipient and the time that the container returns to the terminal (e.g. after the container has been emptied of items destined to a recipient). The prediction of the turn time can be based on one or more factors, such as a given commodity to be transported, a given port involved, and/or the consignee.

A commodity disclosed herein may be seen as an object and/or an item that is to be placed in a container for transport. For example, a commodity may be seen as an item of cargo, e.g., an item of freight, e.g., an object to be shipped. For example, the commodities may be seen as items that can be packed into containers. It is noted that in some examples, the term “commodity” may be used interchangeably with the term “cargo”. For example, a commodity may comprise items that can be placed into containers, such as goods. For example, goods can include material, such as oil, crude oil, raw materials, wood, industrial ingredients, plants (such as fruits and vegetables, seeds, beans), food (such as tea, coffee), fertilizers, paper, metal, chemicals, vehicles, mineral fuels, stones, tiles, glass plastic and rubber, etc. For example, goods can include as consumer goods of manufacturing corporations, generic consumer goods as shoes, clothing, toys and fast-moving-consumer-goods as packaged foods, beverages, toiletries, and medicines. Examples of commodities include rectangular stackable cartons with variable weights and volumes that are transported in one or more dry containers.

A container disclosed herein may be seen as a housing where items to be shipped are enclosed for transport. For example, a container may be seen as a bin. The term container may be used interchangeably with bin in the present disclosure.

A time extension disclosed herein may be seen as an additional period of time (e.g., days, hours) taken to return a container back to the port. The time extension may be selected at booking and not be resulting in additional charges after booking. The time extension can be called a free time extension. The time extension may differ depending on the commodity of a container, the consignee associated with the container, the properties of the container (e.g., type and/or size of the container), the port location, the booking type, the container type etc.). In some examples, the time extension granted may be seen as the extra time which a container may be stored in the port. In some examples, the time extension may be granted by an authority associated with the port. In some examples, the time extension period may be extended. The time extension may for example be selected for one or more containers (e.g., by the consignee).

In some examples, the container may be assigned to an allocated container space in a terminal and/or port. For the delivery of the content of a container to a recipient and/or a destination (e.g., a storage warehouse), the container may be transported (e.g., discharged) to a location outside of a terminal and/or a port. In some examples, failure to remove the container from the terminal and/or port (e.g., allocated container space) prior to time extension expiry may incur additional operations (e.g., additional cost charged to the consignee). The time that the container spends in the terminal and/or port may be seen as demurrage time.

In some examples, detention may be seen as the time that a container stays detainer/retained by a recipient of the container outside the terminal and/or port. In some examples, when the container is not returned to the terminal and/or the port prior to expiry of a time limit, a cost due to detention may be incurred.

Turn time disclosed herein may comprise demurrage turn time and/or detention turn time. Demurrage turn time is for example the time from which a container arrives at a terminal and/or a port to the time the container is collected from the terminal and/or port to be transported to a recipient and/or destination (e.g., for unloading of at least a part of the container). Detention turn time is for example the time from which the container is collected from the terminal and/or port (e.g., for unloading) until the container is returned to the terminal and/or port (e.g., after unloading). For example, the returned container may comprise fewer items than prior to transportation from the terminal and/or port towards the recipient. In some examples, the returned container may be empty.

The turn time parameter disclosed herein may be seen as a parameter indicative of turn time. For example, the turn time parameter can include a value (e.g., integer, decimal, percentage etc.) indicative of the turn time for a container.

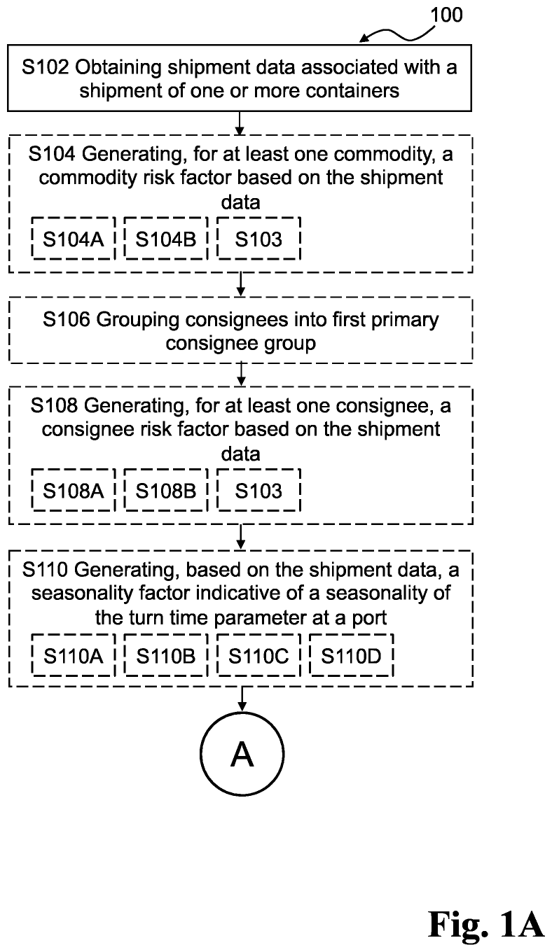

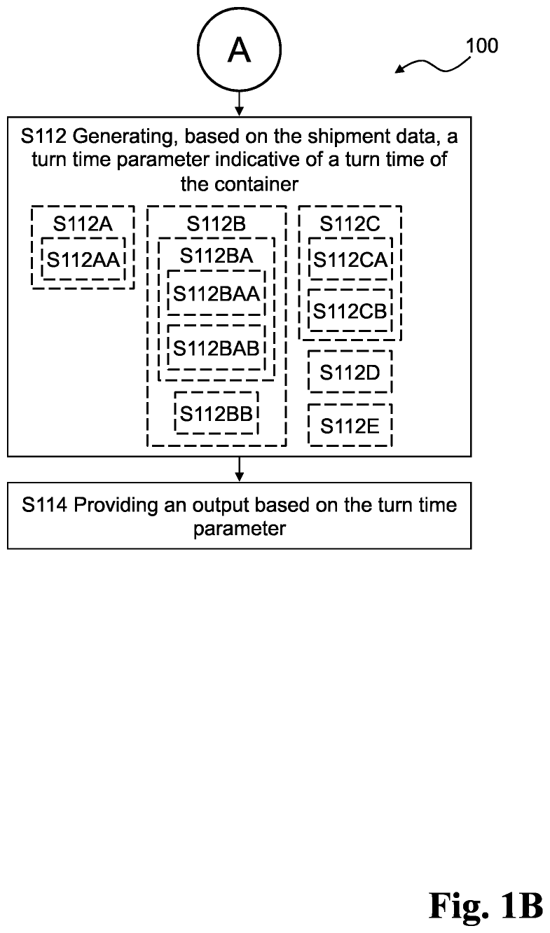

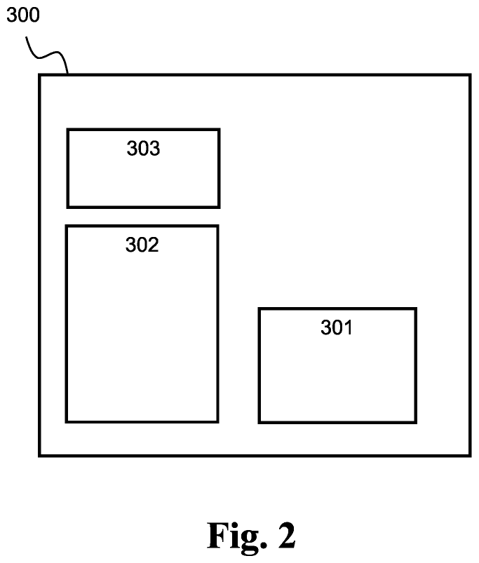

FIG. 1 is a diagram illustrating an exemplary system 1 comprising an example method 100, performed by an electronic device, for predicting a turn time of a container according to this disclosure. The method 100 can be performed for predicting a turn time parameter associated with a container. The method 100 is performed by an electronic device, such as the electronic device disclosed herein, such as electronic device 300 of FIG. 2.

The method 100 comprises obtaining S102 shipment data associated with a shipment of one or more containers. In one or more examples, the shipment of one or more containers can be seen as shipping (e.g., transporting) one or more containers including one or more items. The shipment data comprises information associated with a shipping of one or more items enclosed in one or more containers. In some examples, shipment data comprises information associated with a container. For example, the shipment data comprises information associated with a shipment of one or more containers. For example, shipment data comprises data elements.

In some examples, obtaining shipment data comprises pre-processing the shipment data, such as extracting and/or transforming the shipment data. In some examples, obtaining the shipment data comprises receiving and/or retrieving the shipment data from a storage medium, such as one or more databases which store shipment data. In some examples, obtaining the shipment data comprises obtaining the shipment data from a memory of the electronic device (e.g., electronic device 300 of FIG. 2). In some examples, obtaining the shipment data comprises obtaining (e.g., receiving) the shipment data from one or more external servers.

In one or more example methods, the shipment data comprises one or more of: time extension data associated with a time extension of the container, transaction data associated with one or more transactions, container movement data associated with movement of the one or more containers, commodity data associated with one or more commodities, consignee data associated with one or more consignees, container data associated with the one or more containers, booking data associated with one or more shipment bookings, port data associated with one or more ports for shipment, turn time data, and historical shipment data.

Time extension data may be associated with the shipment of one or more containers. In some examples, time extension data comprises information indicative of time extension available (e.g., bought), granted and/or used (e.g., consumed).

In some examples, transaction data comprises information associated with one or more transactions associated with a consignee. For example, the transaction data may be indicative of a quantity of transactions, such as the number of shipments associated with a consignee (e.g., per port, per container type, per booking type). In other words, transaction data may comprise information indicative of the number of transactions per consignee (e.g., number of transactions between a particular consignor and a particular consignee).

In some examples, container movement data comprises information indicative of the movement of a container. In some examples, the container movement data comprises temporal data associated with one or more events (e.g., container arrival) associated with the shipment of one or more containers. For example, the container movement data comprises information indicative of the arrival date to, discharge date from and/or return date associated with the shipment of one or more containers.

In some examples, commodity data comprises information indicative of the type of commodity and/or a commodity category associated with the shipment of one or more containers. For example, when the commodity is paper, the commodity data comprises information indicative of the commodity being paper.

Consignee data may comprise information indicative of a consignee associated with the shipment of one or more containers. For example, the consignee data may include a consignee identifier, consignee status, one or more parameter indicative of the past detention time for the consignee (e.g. per port and/or per commodity).

In some examples, container data comprises information indicative of container size and/or type. For example, the container data comprises information indicative of the volume of the container. For example, the container data may be indicative of the container being a 20 footer (such as 20 cubic feet) or a 40 footer (e.g., such as 40 cubic feet) container.

In some examples, booking data comprises information associated with a booking of one or more containers. For example, the booking data comprises information indicative of a booking type associated with the shipment of one or more containers. For example, the booking type may be ad-hoc booking (e.g., spot booking) and/or a contractual booking (e.g., the booking may be a part of a contract). For example, a spot booking may be booked online (e.g., as an online service).

Port data may comprise information indicative of a port associated with the container. A port may be seen a facility where cargo containers are trans-shipped between different transport vehicles, for onward transportation. A port can used interchangeably with the term “terminal”. For example, the port data may be indicative of the port associated with the shipment of one or more containers. For example, the port data may comprise information indicative of the geographical location of a port. In some examples, the port data may comprise information indicative of the size of the port, information about capacity of the port, information about statistics regarding demurrage.

Turn time data may comprise information associated with one or more turn time parameter for one or more shipments. For example, the turn time data comprises one or more turn time parameters per booking type, per container type (e.g., property, size and/or volume), per port, and/or per commodity. In some examples, the turn time data comprises information indicative of the turn time for a shipment. In some examples, the turn time data comprises one or more turn time parameters (e.g., present turn time parameters).

In some examples, shipment data comprises historical shipment data. For example, the historical shipment data is associated with the shipment of one or more containers. The historical shipment data may be seen as previous (e.g., past) shipment data. In one or more example methods, the historical shipment data comprises one or more of: historical time extension data associated with a time extension of the container, historical transaction data associated with one or more transactions, historical container movement data associated with movement of the one or more containers, historical commodity data associated with one or more commodities, historical consignee data associated with one or more consignees, historical container data associated with the one or more containers, historical booking data associated with one or more shipment bookings, historical port data associated with one or more ports for shipment, and historical turn time data.

In some examples, obtaining historical shipment data comprises obtaining the historical shipment data from a memory of the electronic device (e.g., electronic device 300 of FIG. 2). In some examples, obtaining the shipment data comprises obtaining (e.g., receiving and/or retrieving) the shipment data from one or more external servers (e.g., a database and/or repository).

In some examples, the historical turn time data may comprise historical information associated with one or more shipments. In some examples, the historical turn time data comprises previous (e.g., past) turn time parameters. In some examples, the historical turn time data comprises the historical average turn time.

In some examples, the historical time extension data comprises information indicative of historical time extension available (e.g., bought), granted and/or used (e.g., consumed). For example, a historical time extension may be seen as a historical time extension.

The method 100 comprises generating (e.g., predicting) S112, based on the shipment data, a turn time parameter indicative of a turn time of the container by applying S112A a prediction model to the shipment data. In some examples, the turn time parameter is indicative of a turn time of one or more containers of a shipment. In some examples, the turn time parameter includes a value (e.g., integer, decimal etc.) indicative of the turn time of a container and expressed e.g. in time unit. In some examples, the turn time parameter may be seen as an estimation and/or a prediction of the turn time for a shipment (e.g., of a container).

In some examples, the turn time parameter is generated based on one or more of: time extension data associated with a time extension of the container, transaction data associated with one or more transactions, container movement data associated with movement of the one or more containers, commodity data associated with one or more commodities, consignee data associated with one or more consignees, container data associated with the one or more containers, booking data associated with one or more shipment bookings, port data associated with one or more ports for shipment, turn time data, and historical shipment data. In other words, in some examples, the prediction model is applied to one or more of: time extension data associated with a time extension of the container, transaction data associated with one or more transactions, container movement data associated with movement of the one or more containers, commodity data associated with one or more commodities, consignee data associated with one or more consignees, container data associated with the one or more containers, booking data associated with one or more shipment bookings, port data associated with one or more ports for shipment, turn time data, and historical shipment data.

In one or more example methods, applying S112A the prediction model comprises applying S112AA, to the shipment data, one or more machine learning techniques and/or a forecasting technique. In one or more example methods, the prediction model is a machine learning model. For example, the prediction model may be configured to carry out one or more machine learning techniques. In one or more example methods, the one or more machine learning techniques comprise one or more of: a linear regression model, a random forest model, a decision tree-based model, and an ensemble model.

A linear regression may be seen as a model characterizing the relationship between the turn time parameter and at least one element of the shipment data by fitting a linear equation to shipment data obtained and can be used to predict the value of the turn time parameter based on at least one element of the shipment data.

Random forest may be seen as an ensemble learning method for classification, regression and other tasks that operates by constructing a collection of decision trees based on the shipment data. For example, the shipment data may be subject to bagging and feature randomness for building each individual tree to predict the turn time parameter.

In one or more examples methods, the prediction model may be configured to carry out one or more forecasting techniques. In one or more example methods, the forecasting technique comprises a time-series forecasting technique. For example, the forecasting technique comprises an Autoregressive Integrated Moving Average (ARIMA) model. In some examples, the forecasting technique comprises an Autoregressive Integrated Moving Average with Explanatory Variable (ARIMAX) model. In some examples, the forecasting technique comprises a Seasonal Auto-Regressive Integrated Moving Average with exogenous factors (SARIMAX) model.

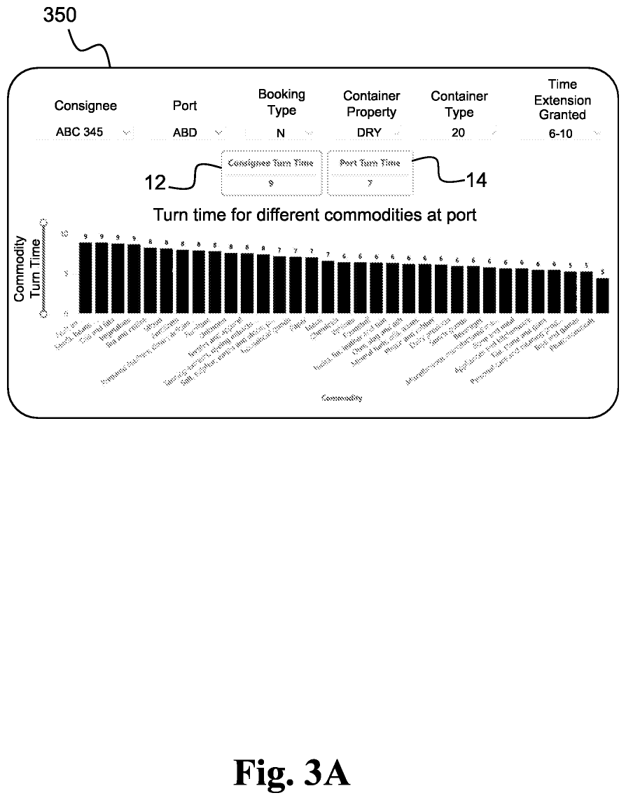

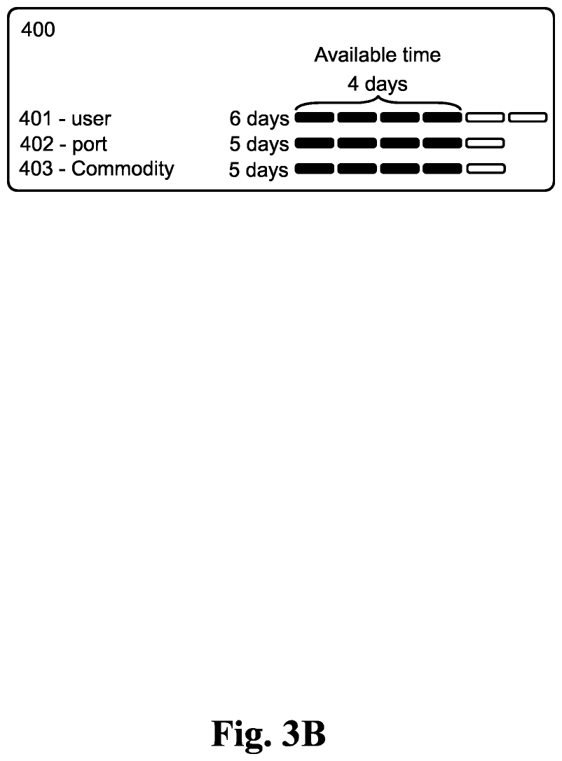

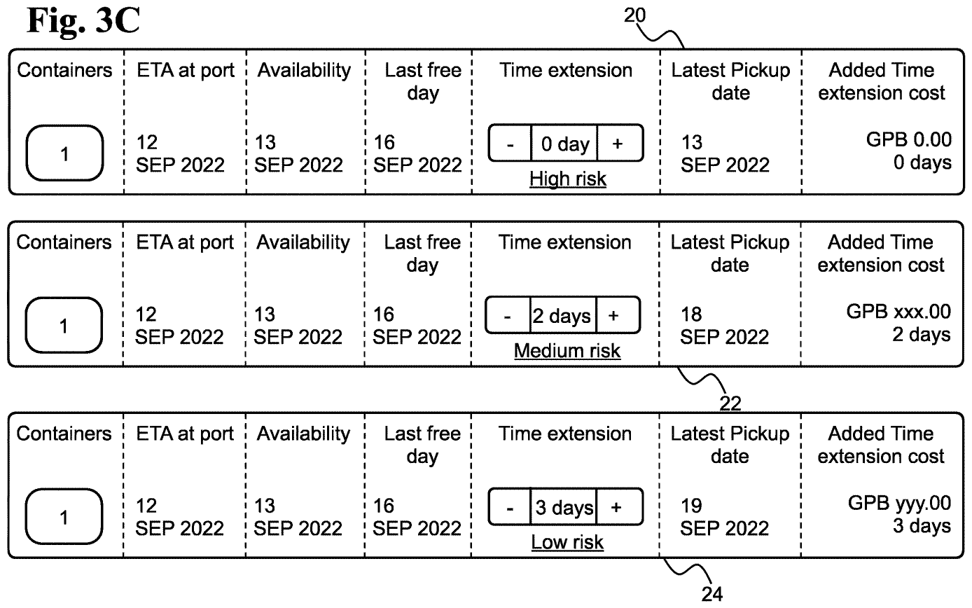

The method 100 comprises providing S114 an output based on the turn time parameter. In some examples, the output comprises information (e.g., one or more values) indicative of the turn time (e.g., predicted turn time) of a container. The output is for example indicative of the turn time parameter for a container. In some examples, the output may be provided for further processing (e.g., for further calculations). In some examples, the output is a time extension parameter calculated based on the turn time parameter. In some examples, providing the output based on the turn time parameter comprises determining the time extension parameter based on the turn time parameter. In some examples, the output may be provided (e.g., to a user and/or consignee) via an interface (e.g., interface of FIGS. 3A-3C). For example, the output may be provided (e.g., displayed) to a user (e.g., consignee) via a user interface (UI). The UI may be provided by the interfaces illustrated in FIGS. 3A-C. The Ul is for example indicative (e.g., representative) of the turn time parameter for a container.

In one or more example methods, the method 100 comprises generating S104, for at least one commodity, a commodity risk factor based on the shipment data. In some examples, the generating, for at least one commodity, of a commodity risk factor comprises generating a commodity risk factor for each commodity of a plurality of commodities. In some examples, the commodity risk factor is associated with the at least one commodity and a port involved in the shipment. A port involved in the shipment is for example a port where the container arrives (e.g., the port of arrival for shipment of a container). A risk factor (e.g., the commodity risk factor) may be expressed as a unit of time (e.g., a day, 15 hours, 400 minutes, etc.). In some examples, a risk factor may be expressed as a coefficient. The commodity risk factor comprises for example a value (e.g., an integer, and/or a real number). In other words, the commodity risk factor may comprise a value indicative of a time period.

In one or more example methods, generating S104 the commodity risk factor comprises calculating S104A, based on the shipment data, one or more commodity distribution parameters for the at least one commodity (e.g. for each commodity). In one or more example methods, the one or more commodity distribution parameters for the at least one commodity are indicative of, for the at least one commodity (e.g. for each commodity), a distribution of at least one of: a delay of return of the container for the at least one commodity, a ratio of used time extension over granted time extension of shipments for the at least one commodity, and a ratio of used time extension over available time extension of shipments for the at least one commodity.

In some examples, the time extension may be seen as free time extension. The one or more commodity distribution parameters are for example associated with a shipment of one or more containers. The one or more commodity distribution parameters are for example values (e.g., integer, fraction, percentage etc.) associated with the commodity of a shipment. The one or more commodity parameters are for example generated based on the historical data (e.g., N year of historical data, where N is a positive integer). The one or more commodity distribution parameters are for example generated per booking type and/or per port.

For example, a delay of return of the container for the at least one commodity may be indicative of a consignee not returning one or more containers (e.g., empty container or appropriately empty) after removal of items. In some examples, the delay of return of the container for the at least one commodity may be a percentile for delayed container returns for each commodity and/or an average delay of containers associated with the at least one commodity (e.g. each commodity). For example, calculating S104A, based on the shipment data, the one or more commodity distribution parameters for the at least one commodity comprises calculating, based on historical data, the percentile of delayed container returns (e.g., return of empty container to the port) for each commodity.

The ratio of used time extension over granted time extension of shipments for the at least one commodity can for example be seen as a ratio (e.g., percentage) indicative of the consumed time extension against the granted time extension for a given commodity. Used time extension may be a value indicative of the time elapsed of the granted time extension for a container. Granted time extension is for example a value indicative of the overall quantity of granted time extension for a container. For example, ratio of used time extension over granted time extension can indicate how much a given commodity consumes of the time extension.

In some examples, the ratio of used time extension over available time extension of shipments for the at least one commodity (e.g. for each commodity) may be seen as a ratio (e.g., a percentage) indicative of the proportion of time extension used against the time extension purchased (e.g., by the consignee) for the at least one commodity (e.g. for each commodity). The available time extension may for example be seen as quantity of time extension purchased for the one or more containers (e.g., for a particular shipment and/or port). For example, the ratio of used time extension over available time extension of shipments for the at least one commodity (e.g. for each commodity) indicates how much of the time extension the user or consignee actually used.

In one or more example methods, generating S104 the commodity risk factor (e.g. for each commodity and for a given port) comprises generating S104B the commodity risk factor based on the one or more commodity distribution parameters (e.g. for each commodity). In one or more example methods, generating S104 the commodity risk factor comprises applying S103 a standardization function to the one or more commodity distribution parameters and/or to the one or more consignee distribution parameters (e.g. for each commodity). In some examples, the standardization function provides an output that is in the range between 0 and 1. In one or more example methods, the standardization function is a sigmoidal function. In one or more example methods, the standardization function is a tanh normalization function and/or a Rectified Linear Unit (relu) function. In some examples, generating S104 the commodity risk factor comprises generating a commodity risk factor associated with a port. For example, each port may be associated with a respective commodity risk factor. In one or more example methods, generating S104 the commodity risk factor comprises applying S103 a standardization function to the one or more commodity distribution parameters.

In one or more example methods, the method 100 comprises grouping S106 consignees into first primary consignee group comprising consignees existing in a turn time system of the electronic device, and a first secondary consignee group comprising consignees not existing in the turn time system. For example, the first primary consignee group comprises one or more existing consignees. For example, the first secondary consignee group comprises one or more new consignees.

The turn time system may be seen as the system configured to perform the method disclosed herein. The electronic device (e.g., the electronic device 300 of FIG. 2) may be configured to execute the turn time system.

In some examples, the first primary consignee group comprises consignees associated with turn time system. For example, the first primary consignee group comprises consignees already associated with historical shipment data (e.g., stored in the memory 301 of FIG. 2). In other words, the first primary consignee group may be seen as comprising existing consignees (e.g., already existing on the turn time system). In some examples, the first secondary consignee group comprises consignees not associated with shipments of the turn time system. For example, the first primary consignee group comprises consignees not associated with historical shipment data (e.g., stored in the memory 301 of FIG. 2). In other words, the first secondary consignee group may be seen as comprising new consignees (e.g., not already existing on the turn time system).

In one or more example methods, the method 100 comprises generating S108, for at least one consignee, a consignee risk factor based on the shipment data.

The consignee risk factor may be expressed as a unit of time (e.g., 1 day, 15 hours, 400 minutes, etc.). In some examples, the consignee risk factor may be expressed as a coefficient. The consignee risk factor comprises for example a value (e.g., an integer and/or a real number). In other words, the consignee risk factor may comprise a value indicative of a time period. In some examples, generating a consignee risk factor based on the shipment data comprises generating a consignee risk factor based on the shipment data for each consignee of a plurality of consignees of the first primary consignee group. In one or more example methods, generating S108 the consignee risk factor, based on the shipment data comprises calculating S108A, based on the shipment data, one or more consignee distribution parameters for the at least one consignee. In one or more example methods, the one or more consignee distribution parameters for the at least one commodity are indicative of, for the at least one commodity, a distribution of at least one of: a proportion of delayed containers for the at least one consignee, a ratio of used time extension over granted time extension of shipments for the at least one consignee, and a ratio of used time extension over available time extension of shipments for the at least one consignee. In some examples the one or more consignee distribution parameters are calculated (such As for each consignee) based on one or more of: time extension data associated with a time extension of the container, transaction data associated with one or more transactions, container movement data associated with movement of the one or more containers, commodity data associated with one or more commodities, consignee data associated with one or more consignees, container data associated with the one or more containers, booking data associated with one or more shipment bookings, port data associated with one or more ports for shipment, turn time data, and historical shipment data.

The consignee risk factor is for example generated according to S108 for existing consignees such as consignees of the first primary consignee group.

The one or more consignee distribution parameters are for example associated with a shipment of one or more containers. The one or more consignee distribution parameters are for example values (e.g., integer, fraction, percentage, percentile etc.) associated with the consignee of a shipment.

The proportion of delayed containers for the at least one consignee, may be indicative of a consignee not returning one or more containers (e.g., empty containers) after removal of items. In some examples, the delay of return of the container for the at least one consignee may be an average delay of containers associated with the consignee. For example, the method comprises, based on historical data, calculating the percentile (e.g., proportion) of delayed container returns (e.g., return of empty container to the port) for each commodity.

The ratio of used time extension over granted time extension of shipments for the at least one consignee may be seen as a ratio (e.g., a percentage, and/or percentile) indicative of the proportion of time extension used against the time extension purchased for a consignee.

The ratio of used time extension over available time extension of shipments for the at least one consignee may be seen as a ratio (e.g., a percentage, and/or percentile) indicative of the proportion of time extension used against the time extension purchased (e.g., by the consignee) for the at least one consignee. In some examples, available time extension may be seen as time extension selectable by. In other words, available time extension may be seen as additional time for a container which may be purchased for example by the consignee.

In one or more example methods, generating S108 the consignee risk factor, based on the shipment data comprises generating S108B the consignee risk factor based on the one or more consignee distribution parameters. In one or more example methods, generating S108 the consignee risk factor comprises applying S103 a standardization function to the one or more commodity distribution parameters and/or to the one or more consignee distribution parameters.

In one or more example methods, generating S108 the consignee risk factor comprises applying S103 a standardization function to the one or more consignee distribution parameters.

In one or more example methods, the method 100 comprises generating S110, based on the shipment data, a seasonality factor indicative of a seasonality of the turn time parameter at a port. In some examples, the method comprises generating, based on the shipment data, a seasonality factor indicative of a seasonality of the turn time parameter at a port and/or for container type (e.g., property (e.g. dry, refrigerated, premium), size and/or volume) and/or commodity. In one or more example methods, generating, based on the shipment data, a seasonality factor indicative of a seasonality of the turn time parameter at a port comprises applying one or more forecasting techniques. In one or more examples the seasonality factor is generated based on one or more of: time extension data associated with a time extension of the container, transaction data associated with one or more transactions, container movement data associated with movement of the one or more containers, commodity data associated with one or more commodities, consignee data associated with one or more consignees, container data associated with the one or more containers, booking data associated with one or more shipment bookings, port data associated with one or more ports for shipment, turn time data, and historical shipment data. In one or more examples the seasonality factor is generated based on transaction data associated with one or more transactions.

In some examples, the method comprises generating, based on the historical shipment data, a seasonality factor indicative of a seasonality of the turn time parameter at a port. In some examples, seasonality may be seen as a characteristic of a time series in which the data experiences regular and predictable changes (e.g., patterns) that may recur over a time period (such as every calendar year). For example, seasonality may be seen as seasonal patterns associated with a data set (e.g., a time series). The seasonality factor may be a value (e.g., decimal, fraction, integer) associated with the seasonality of the turn time parameter at a port. For example, the seasonality factor may be a value indicative of a time period (e.g., 1 day, 0 days).

In one or more example methods, generating S110, based on the shipment data, the seasonality factor comprises classifying S110A, based on the shipment data (e.g. based on at least on consignee data and/or transaction data for a consignee), consignees into a second primary consignee group and a second secondary consignee group. In some examples, generating, based on the historical shipment data (e.g., historical transaction data and/or historical consignee data, e.g., number of transactions per consignee), the seasonality factor comprises classifying, based on the shipment data, consignees into a second primary consignee group and a second secondary consignee group. In other words, generating the seasonality factor comprises classifying consignees into a second primary consignee group and a second secondary consignee group, based on the shipment data.

In some examples, classifying the consignees into a second primary consignee group and a second secondary consignee group comprises determining whether the number of transactions (e.g., shipments) associated with a consignee satisfies a criterion. For example, the criterion is based on a threshold. The threshold is for example a value (e.g., an integer, a real number, etc.). The threshold is for example 10, 20, 30, 40, 100, 200, 400. For example, the threshold is between 20-80, 30-70 and/or 40-60. In some examples, the threshold is 50. For example, consignees associated (e.g., of the turn time system) with more than 50 transactions are grouped (e.g., classified) into the second primary consignee group. For example, consignees associated (e.g., in the turn time system) with less than 50 transactions are grouped (e.g., classified) into the second secondary consignee group.

The second primary consignee group for example comprises consignees associated with a number of shipments greater than a threshold value (e.g., transactions between a consignee and consignor), thereby satisfying the criterion. For example, the second primary consignee group comprises consignee associated with more than 50 transactions. Consignees grouped into the second primary consignee group may be seen as large consignees.

The second secondary consignee group for example comprises consignees associated with a number of shipments equal or lower than a threshold value (e.g., transactions between a consignee and consignor), thereby not satisfying the criterion. For example, the second primary consignee group comprises consignee associated with less than 50 transactions. Consignees grouped into the second secondary consignee group may be seen as small consignees.

In some examples, whether the number of transactions per consignee (e.g., obtained from historical transaction data associated with the consignee) satisfies the criterion depends on whether the number of transactions per consignee is greater than or less than the threshold. For example, when the number of transactions per consignee is greater than the threshold, the criterion can be seen as being satisfied by the number of transactions per consignee. For example, when the number of transactions per consignee is less than the threshold, the criterion can be seen as not being satisfied by the number of transactions associated with a consignee.

For example, classifying, based on the shipment data, consignees into a second primary consignee group and a second secondary consignee group comprises, in accordance with the criterion being satisfied, grouping the consignee into the second primary consignee group. For example, classifying, based on the shipment data, consignees into a second primary consignee group and a second secondary consignee group comprises, in accordance with the criterion not being satisfied, grouping the consignee into the second secondary consignee group.

In one or more example methods, generating S110, based on the shipment data, the seasonality factor comprises obtaining S110B for one or more consignees of the second primary consignee group, a first seasonality value associated with the turn time parameter of a container and the port for a present time. The first seasonality value is for example indicative of the seasonality of the turn time of a container and the port. In some examples, the first seasonality value is a number (e.g., an integer). For example, the first seasonality value may be a number between 0 and 1. In some examples, a first seasonality value of 1 (or close to 1) may be indicative of a high seasonality. In some examples, a first seasonality value of 0 (or close to 0) may be indicative of a low seasonality. In some examples, the method may comprise forgoing obtaining the first seasonality value for consignees of the second secondary consignee group as they are associated with a lack of shipment data.

In some examples, when the first seasonality value is less than a threshold value (e.g., 0.5), the first seasonality value may be seen as 0 (e.g., no seasonality). For example, when the first seasonality value is greater than a threshold value (e.g., 0.5), the first seasonality value may be seen as 1 (e.g., significant seasonality).

In one or more example methods, generating S110, based on the shipment data, the seasonality factor comprises determining S110C, based on the first seasonality value and a forecasting technique, a second seasonality value associated with the turn time parameter and the port for each time period of a year. In some examples, the forecasting technique may be a time series forecasting technique (e.g., ARIMA, SARIMAX, etc.).

In one or more example methods, generating S110, based on the shipment data, the seasonality factor comprises assigning S110D the second seasonality value to a seasonality factor indicative of the turn time parameter for a specific time of the year.

The specific time of the year is for example a specific month of the year (e.g., February). For example, the seasonality factor is indicative of the turn time parameter for a specific month of the year.

In one or more example methods, the turn time parameter comprises a consignee turn time parameter associated with a consignee of the container. The consignee turn time parameter is for example indicative of a turn time of a container associated with a consignee. In some examples, the consignee turn time parameter is a value indicative of the turn time for a container associated with a consignee at a port. For example, the consignee turn time parameter is a value (e.g., an integer, decimal, etc.) indicative of a time period. For example, the consignee turn time parameter may be expressed as a unit of time (e.g., 1 day, 15 hours, 400 minutes, etc.).

In one or more example methods, generating S112, based on the shipment data, the turn time parameter comprises generating S112B, based on the shipment data, the consignee turn time parameter.

In one or more example methods, generating S112B, based on the shipment data, the consignee turn time parameter comprises generating S112BA a model-based consignee turn time parameter based on the shipment data and at least one of the one or more machine learning techniques. In some examples, generating the model-based consignee turn time parameter comprises applying at least one of the one or more machine learning techniques to the shipment data (e.g., the historical shipment data). The model-based consignee turn time parameter is for example a value indicative of the turn time for a container associated with a consignee at a port. In some examples, the model-based consignee turn time parameter is generated, based on the shipment data, by applying a linear regression model, a random forest model, a tree based model, an ensemble model, etc.). In some examples, the model-based consignee turn time parameter may be seen as the output of the one or more machine learning models. In some examples, the one or more machine learning model is based on the container type (e.g. 20-footer) and/or the booking type (e.g., Spot). In some examples, one or more machine learning techniques may comprise dynamic autoregression machine learning techniques.

It may be appreciated that in some examples, a machine learning model is generated for each combination of consignee, commodity, and port.

In one or more example methods, generating S112BA, based on the shipment data and the at least one of the one or more machine learning techniques, the model-based consignee turn time parameter comprises generating S112BAA a set of aggregated data based on historical time extension data with corresponding historical turn time data at each port.

In some examples, the set of aggregated data comprises time extension data (e.g., historical time extension data) and/or turn time data (e.g., historical turn time data) per port. In some examples, historical time extension data comprises historical information indicative of indicative of historical time extension available, granted and/or used. In some examples, the historical turn time data comprises previous (e.g., past) turn time parameters.

In some examples, generating, based on the shipment data and the at least one of the one or more machine learning techniques, the model-based consignee turn time parameter comprises generating a set of aggregated data based on historical time extension data with corresponding historical turn time data at each port, for each container type, and/or each booking type. In some examples, at least one of the one or more machine learning techniques is associated with the booking type and/or container type.

In one or more examples, generating the model-based consignee turn time parameter comprises aggregating and/or inputting the time extension data, turn time data and/or the port data and applying one or more machine learning models to the aggregated result. The time extension data for example corresponds to the turn time data for a port. In one or more examples, generating the model-based consignee turn time parameter comprises aggregating and/or inputting the historical time extension data (e.g., time granted), historical turn time data and/or the historical port data and applying this to the one or more machine learning models. The historical time extension data for example corresponds to the historical turn time data for a port.

In one or more example methods, generating S112BA, based on the shipment data and the at least one of the one or more machine learning techniques, the model-based consignee turn time parameter comprises applying S112BAB at least one of the one or more machine learning techniques to the set of aggregated data.

In some examples, applying the one or more machine learning techniques to the set of aggregated data comprises applying a machine learning based regression model for booking type, container type, and/or port. For example, applying the one or more machine learning techniques to the set of aggregated data comprises applying a machine learning based regression model for a SPOT 20-footer, SPOT 40-footer, CONTRACTUAL 20-footer and/or CONTRACTUAL 40-footer, wherein SPOT and CONTRACTUAL are booking types and wherein 20-footer and 40-footer are container types. For example, each machine learning based regression model may be associated with a port.

In one or more example methods, generating S112B, based on the shipment data, the consignee turn time parameter comprises generating S112BB the consignee turn time parameter based on the model-based consignee turn time parameter and one or more of: the commodity risk factor, the consignee risk factor, and the seasonality factor. In some examples, the consignee turn time parameter is derived based on the model-based consignee turn time parameter and one or more of: the commodity risk factor, the consignee risk factor, and the seasonality factor. In some examples, generating the consignee turn time parameter comprises summing one or more of the model-based consignee turn time parameter, the commodity risk factor, the consignee risk factor and/or the seasonality factor. For example, the consignee turn time parameter may be associated with a consignee and/or a commodity associated with a shipment of a container. The consignee turn time parameter may be seen as a turn time prediction indicative of the turn time for a container at a port for a given consignee.

In one or more example methods, generating S112, based on the shipment data, the turn time parameter comprises generating S112C, based on the shipment data, a consignee turn time parameter associated with at least one consignee of the first secondary consignee group (e.g. new consignees).

In one or more example methods, generating S112C the consignee turn time parameter associated with the at least one consignee of the first secondary consignee group comprises identifying S112CA an earliest transaction of the at least one consignee, such as the earliest transaction for a given consignee. Identifying an earliest transaction of the at least one consignee for example comprises ranking the transactions of the consignees (e.g., chronologically). In some examples, identifying an earliest transaction of the at least one consignee comprises identifying the one more commodities associated with the earliest transaction.

In one or more example methods, generating S112C the consignee turn time parameter associated with the at least one consignee of the first secondary consignee group comprises determining S112CB, for a commodity, the consignee turn time parameter associated with the at least one consignee of the first secondary group based on the consignee turn time parameters of consignees of the first primary consignee group and of the first secondary consignee group.

In some examples, generating a consignee turn time parameter associated with at least one consignee of the first secondary consignee group (e.g., new consignees) comprises averaging the consignee turn time parameter, for a given commodity, for all consignees of the first primary consignee group (e.g., existing consignees).

In some examples, commodity data may not be available to the turn time system. For example, when commodity data is not available, generating the consignee turn time parameter associated with at least one consignee of the first secondary consignee group (e.g., new consignees) comprises averaging the consignee turn time parameter, for all commodities and/or for all consignees of the first primary consignee group (e.g., existing consignees).

In one or more example methods, the turn time parameter comprises a port turn time parameter associated with a port. In some examples, the turn time parameter comprises a port turn time parameter associated with a port, for example per month, per commodity, and/or per container type (e.g., size and/or volume).

In some examples, the port turn time parameter may be indicative of a turn time at a port of one or more containers of a shipment. In some examples, the port turn time parameter may be seen as a prediction (e.g., a forecast) of a turn time at a port of one or more containers of a shipment.

In one or more example methods, generating S112, based on the shipment data, the turn time parameter comprises generating S112D, based on the shipment data, the port turn time parameter by applying the forecasting technique to the shipment data.

In some examples, generating, based on the shipment data, the turn time parameter comprises generating, based on the shipment data, the port turn time parameter by applying one or more time series forecasting techniques (e.g., ARIMA, SARIMAX, etc.) to the shipment data. In some examples, generating the port turn time parameter comprises applying a forecasting technique (e.g., forecasting model) associated with a particular time period (e.g., month), commodity and/or container type (e.g., property, size and/or volume).

In one or more example methods, the turn time parameter comprises a commodity turn time parameter associated with a commodity (e.g. for a given port). In some examples, the turn time parameter comprises a commodity turn time parameter associated with a commodity, for example per month, per port, and/or per container type (e.g., property, size and/or volume).

In some examples, the commodity turn time parameter may be indicative of a turn time for a commodity associated with one or more containers of a shipment. In some examples, the commodity turn time parameter may be seen as a prediction (e.g., a forecast) of a turn time of one or more containers of a shipment associated with a given commodity.

In one or more example methods, generating S112, based on the shipment data, the turn time parameter comprises generating S112E, based on the shipment data, the commodity turn time parameter by applying the forecasting technique to the shipment data.

In some examples, generating, based on the shipment data, the turn time parameter comprises generating, based on the shipment data, the commodity turn time parameter by applying one or more time series forecasting techniques (e.g., ARIMA, SARIMAX, etc.) to the shipment data. In some examples, generating the commodity turn time parameter comprises applying a forecasting technique (e.g., forecasting model) associated with a particular time period (e.g., month), port (e.g., port location) and/or container type (e.g., property, size and/or volume).

FIG. 2 is a block diagram illustrating an exemplary electronic device according to this disclosure. The electronic device 300 comprises memory circuitry 301, processor circuitry 302, and an interface 303. The electronic device 300 is configured to perform any of the methods disclosed in FIGS. 1A-B. In other words, the electronic device 300 is configured for predicting the turn time of a container.

The electronic device 300 is configured to obtain (e.g., via memory circuitry 301 and/or interface 303) shipment data associated with a shipment of one or more containers.

The electronic device 300 is configured to generate (e.g., via processor 302), based on the shipment data, a turn time parameter indicative of a turn time of the container by applying a prediction model to the shipment data.

The electronic device 300 is configured to provide (e.g., via processor 302 and/or interface 303) an output based on the turn time parameter.

The processor circuitry 302 is optionally configured to perform any of the operations disclosed in FIGS. 1A-B (such as any one or more of: S102, S103, S104, S104A, S104B, S106, S108, S108A, S108B, S110, S110A, S110B, S110C, S110D, S112, S112A, S112AA, S112B, S112BA, S112BAA, S112BAB, S112BB, S112C, S112CA, S112CB, S112D, S112E). The operations of the electronic device 300 may be embodied in the form of executable logic routines (e.g., lines of code, software programs, etc.) that are stored on a non-transitory computer readable medium (e.g., the memory circuitry 301) and are executed by the processor circuitry 302).

Furthermore, the operations of the electronic device 300 may be considered a method that the electronic device 300 is configured to carry out. Also, while the described functions and operations may be implemented in software, such functionality may as well be carried out via dedicated hardware or firmware, or some combination of hardware, firmware and/or software.

The memory circuitry 301 may be one or more of a buffer, a flash memory, a hard drive, a removable media, a volatile memory, a non-volatile memory, a random access memory (RAM), or other suitable device. In a typical arrangement, the memory circuitry 301 may include a non-volatile memory for long term data storage and a volatile memory that functions as system memory for the processor circuitry 302. The memory circuitry 301 may exchange data with the processor circuitry 302 over a data bus. Control lines and an address bus between the memory circuitry 301 and the processor circuitry 302 also may be present (not shown in FIG. 2). The memory circuitry 301 is considered a non-transitory computer readable medium.

The memory circuitry 301 may be configured to store shipment data, historical shipment data, turn time parameter, prediction model, commodity risk factor, consignee risk factor, seasonality factor, one or more commodity distribution parameters, one or more consignee distribution parameters, first primary consignee group, first secondary consignee group, second primary consignee group, second secondary consignee group, seasonality factor, first seasonality value, and/or second seasonality value in a part of the memory.

FIGS. 3A-C show example representations of example outputs of the disclosed technique. FIG. 3A shows a user interface 350 for providing a predicted turn time parameter for a container according to this disclosure, which can be an example output of the disclosed method.

The user interface 350 includes user interface objects (e.g., buttons drop down menus) that may be toggled by a user. For example, consignee, port, booking type, container property (such as a container type and/or a container size) and/or time extension granted, may be toggled and/or selected by the user. As an example, the user may update the container type from 20 to 40 (e.g., 40 footer).

The user interface 350 shows a predicted turn time parameter associated with a consignee, a port and a commodity. The user interface 350 comprises a user interface object 12 representative of the consignee (e.g., predicted consignee turn time) turn time parameter for a container. For example, the user interface object 12 shows a consignee turn time parameter (e.g., a predicted consignee turn time parameter) of 9 days.

The user interface 350 comprises a user interface object 14 representative of the port turn time parameter (e.g., predicted port turn time parameter) for a container. For example, the user interface object 14 shows a port turn time parameter (e.g., a predicted port turn time parameter) of 7 days.

The user interface 350 shows optionally a bar chart representative of the predicted commodity turn time parameter in days for different commodities. For example, for the commodity of “Wood”, the bar chart shows a commodity turn time parameter (such as a predicted commodity turn time parameter) of 8 days.

The user is provided with the turn time parameters which reflect a dynamic internal state of the shipping system and supports the selection of time extension. For example, the user in user interface 350 selects a time extension of 6-10 days, which appears based on the consignee turn time parameter, the commodity turn time parameters, and/or the port turn time parameter.

FIG. 3B shows a user interface 400 for guidance for usage of time extension.

The user interface 400 includes a user interface object 401 representative of user time extension indicator for the container being booked, such as average time extension for a consignee. For example, the user interface object 401 shows that a time extension of 6 days is possible when considering the consignee.

The user interface 400 can include a user interface object 402 representative of port available time for the port selected for the shipping, such as average time extension for this port. For example, the user interface object 402 shows that a time extension of 5 days is possible when considering the port.

The user interface 400 can include a user interface object 403 representative of port available time for the commodity part of the shipping, such as average available time for this port. For example, the user interface object 402 shows that a time extension of 5 days is possible when considering the commodity and/or industry.

The user interface 400 shows the presently available time is 4 days, and the time extensions of 1 to 2 days depending on the factor being the consignee, the port, and the commodity.

The output of the disclosed method can be used for determining the time extension(s) for each factor (such as the consignee, the port, and the commodity).

FIG. 3C shows user interfaces 20, 22, 24 for booking a container.

User interfaces 20, 22, 24 are concerning container 1 with respective user interface objects representative of: an estimated time of arrival at the port being 12 Sep. 2022, availability on 13 Sep. 2022, last free day 16 Sep. 2022, time extension toggle for adjusting days for time extension, latest pickup dates, and added time extension cost in GBP.

For example, a time extension of 0 days (i.e. no time extension) is seen a high risk to having to D&D costs. For example, this can be because at this port and/or for this commodity, there is turn time predicted that is higher than 0 day.

For example, a time extension of 2 days is seen a medium risk to having to D&D costs. For example, this can be because at this port and/or for this commodity, there is turn time predicted that is closer to 2 days.

For example, a time extension of 3 days is seen a low risk to having to D&D costs. For example, this can be because at this port and/or for this commodity, there is turn time predicted that is less than 3 days.

Embodiments of methods and products (electronic device) according to the disclosure are set out in the following items:

Item 1. A method, performed by an electronic device, for predicting turn time for a container, the method comprising:
obtaining shipment data associated with a shipment of one or more containers;
generating, based on the shipment data, a turn time parameter indicative of a turn time of the container by applying a prediction model to the shipment data; and
providing an output based on the turn time parameter.

Item 2. The method according to item 1, wherein applying the prediction model comprises applying, to the shipment data, one or more machine learning techniques and/or a forecasting technique.

Item 3. The method according to item 2, wherein the one or more machine learning techniques comprise one or more of: a linear regression model, a random forest model, a decision tree-based model, and an ensemble model, and wherein the forecasting technique comprises a time-series forecasting technique.

Item 4. The method according to any of the previous items, wherein the shipment data comprises one or more of: time extension data associated with a time extension of the container, transaction data associated with one or more transactions, container movement data associated with movement of the one or more containers, commodity data associated with one or more commodities, consignee data associated with one or more consignees, container data associated with the one or more containers, booking data associated with one or more shipment bookings, port data associated with one or more ports for shipment, turn time data, and historical shipment data.

Item 5. The method according to any of the previous items, wherein the method comprises generating, for at least one commodity, a commodity risk factor based on the shipment data, wherein the commodity risk factor is associated with the at least one commodity and a port involved in the shipment.

Item 6. the method according to item 5, wherein generating the commodity risk factor comprises:
calculating, based on the shipment data, one or more commodity distribution parameters for the at least one commodity, wherein the one or more commodity distribution parameters for the at least one commodity are indicative of, for the at least one commodity, a distribution of at least one of:
   a delay of return of the container for the at least one commodity,
   a ratio of used time extension over granted time extension of shipments for the at least one commodity, and
   a ratio of used time extension over available time extension of shipments for the at least one commodity; and
generating the commodity risk factor based on the one or more commodity distribution parameters.

Item 7. The method according to any of the previous items, wherein the method comprises grouping consignees into first primary consignee group comprising consignees existing in a turn time system of the electronic device, and a first secondary consignee group comprising consignees not existing in the turn time system.

Item 8. The method according to any of the previous items, wherein the method comprises generating, for at least one consignee, a consignee risk factor based on the shipment data.

Item 9. The method according to item 8, wherein generating the consignee risk factor, based on the shipment data comprises:
calculating, based on the shipment data, one or more consignee distribution parameters for the at least one consignee, wherein the one or more consignee distribution parameters for the at least one commodity are indicative of, for the at least one commodity, a distribution of at least one of:
   a proportion of delayed containers for the at least one consignee,
   a ratio of used time extension over granted time extension of shipments for the at least one consignee, and
a ratio of used time extension over available time extension of shipments for the at least one consignee; and
generating the consignee risk factor based on the one or more consignee distribution parameters.

Item 10. The method according to items 6 and/or 9, wherein generating the commodity risk factor and/or the consignee risk factor comprises applying a standardization function to the one or more commodity distribution parameters and/or to the one or more consignee distribution parameters.

Item 11. The method according to any of the previous items, wherein the method comprises generating, based on the shipment data, a seasonality factor indicative of a seasonality of the turn time parameter at a port.

Item 12. The method according to item 11, wherein generating, based on the shipment data, the seasonality factor comprises:
classifying, based on the shipment data, consignees into a second primary consignee group and a second secondary consignee group;
obtaining for one or more consignees of the second primary consignee group, a first seasonality value associated with the turn time parameter of a container and the port for a present time;
determining, based on the first seasonality value and a forecasting technique, a second seasonality value associated with the turn time parameter and the port for each time period of a year; and
assigning the second seasonality value to a seasonality factor indicative of the turn time parameter for a specific time of the year.

Item 13. The method according to any of the previous items, wherein the turn time parameter comprises a consignee turn time parameter associated with a consignee of the container.

Item 14. The method according to item 13, wherein generating, based on the shipment data, the turn time parameter comprises generating, based on the shipment data, the consignee turn time parameter.

Item 15. The method according to item 14, wherein generating, based on the shipment data, the consignee turn time parameter comprises generating a model-based consignee turn time parameter based on the shipment data and at least one of the one or more machine learning techniques.

Item 16. The method according to item 15, wherein generating, based on the shipment data and at least one of the one or more machine learning techniques, the model-based consignee turn time parameter comprises:
generating a set of aggregated data based on historical time extension data with corresponding historical turn time data at each port; and
applying at least one of the one or more machine learning techniques to the set of aggregated data.

Item 17. The method according to any of items 11-12, and 14-15, wherein generating, based on the shipment data, the consignee turn time parameter comprises generating the consignee turn time parameter based on the model-based consignee turn time parameter and one or more of: the commodity risk factor, the consignee risk factor, and the seasonality factor.

Item 18. The method according to items 7 and 14 and any of items 8-13 and 15-17, wherein generating, based on the shipment data, the turn time parameter comprises generating, based on the shipment data, a consignee turn time parameter associated with at least one consignee of the first secondary consignee group.

Item 19. The method according to item 18, wherein generating the consignee turn time parameter associated with the at least one consignee of the first secondary consignee group comprises:
identifying an earliest transaction of the at least one consignee; and
determining, for a commodity, the consignee turn time parameter associated with the at least one consignee of the first secondary group based on the consignee turn time parameters of consignees of the first primary consignee group and of the first secondary consignee group.

Item 20. The method according to any of the previous items, wherein the turn time parameter comprises a port turn time parameter associated with a port.

Item 21. The method according to item 20, wherein generating, based on the shipment data, the turn time parameter comprises generating, based on the shipment data, the port turn time parameter by applying the forecasting technique to the shipment data.

Item 22. The method according to any of the previous items, wherein the turn time parameter comprises a commodity turn time parameter associated with a commodity.

Item 23. The method according to item 22, wherein generating, based on the shipment data, the turn time parameter comprises generating, based on the shipment data, the commodity turn time parameter by applying the forecasting technique to the shipment data.

Item 24. An electronic device comprising memory circuitry, processor circuitry, and an interface, wherein the electronic device is configured to perform any of the methods according to any of items 1-23.

Item 25. A computer readable storage medium storing one or more programs, the one or more programs comprising instructions, which when executed by an electronic device cause the electronic device to perform any of the methods of items 1-23.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1-3C comprises some circuitries or operations which are illustrated with a solid line and some circuitries or operations which are illustrated with a dashed line. The circuitries or operations which are comprised in a solid line are circuitries or operations which are comprised in the broadest example embodiment. The circuitries or operations which are comprised in a dashed line are example embodiments which may be comprised in, or a part of, or are further circuitries or operations which may be taken in addition to the circuitries or operations of the solid line example embodiments. It should be appreciated that these operations need not be performed in order presented. Furthermore, it should be appreciated that not all of the operations need to be performed. The exemplary operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the exemplary embodiments may be implemented at least in part by means of both hardware and software, and that several “means”, “units” or “devices” may be represented by the same item of hardware.

The various exemplary methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method, performed by an electronic device, for predicting turn time for a container, the method comprising:
obtaining shipment data associated with a shipment of one or more containers;
generating, based on the shipment data, a turn time parameter indicative of a turn time of the container by applying a prediction model to the shipment data; and
providing an output based on the turn time parameter.

2. The method according to claim 1, wherein applying the prediction model comprises applying, to the shipment data, one or more machine learning techniques and/or a forecasting technique.

3. The method according to claim 2, wherein the one or more machine learning techniques comprise one or more of: a linear regression model, a random forest model, a decision tree-based model, and an ensemble model, and wherein the forecasting technique comprises a time-series forecasting technique.

4. The method according to claim 1, wherein the shipment data comprises one or more of: time extension data associated with a time extension of the container, transaction data associated with one or more transactions, container movement data associated with movement of the one or more containers, commodity data associated with one or more commodities, consignee data associated with one or more consignees, container data associated with the one or more containers, booking data associated with one or more shipment bookings, port data associated with one or more ports for shipment, turn time data, and historical shipment data.

5. The method according to claim 1, wherein the method comprises generating, for at least one commodity, a commodity risk factor based on the shipment data, wherein the commodity risk factor is associated with the at least one commodity and a port involved in the shipment.

6. The method according to claim 5, wherein generating the commodity risk factor comprises:
calculating, based on the shipment data, one or more commodity distribution parameters for the at least one commodity, wherein the one or more commodity distribution parameters for the at least one commodity are indicative of, for the at least one commodity, a distribution of at least one of:
a delay of return of the container for the at least one commodity,
a ratio of used time extension over granted time extension of shipments for the at least one commodity, and
a ratio of used time extension over available time extension of shipments for the at least one commodity; and
generating the commodity risk factor based on the one or more commodity distribution parameters.

7. The method according to claim 1, wherein the method comprises grouping consignees into first primary consignee group comprising consignees existing in a turn time system of the electronic device, and a first secondary consignee group comprising consignees not existing in the turn time system.

8. The method according to claim 1, wherein the method comprises generating, for at least one consignee, a consignee risk factor based on the shipment data.

9. The method according to claim 8, wherein generating the consignee risk factor, based on the shipment data comprises:
calculating, based on the shipment data, one or more consignee distribution parameters for the at least one consignee, wherein the one or more consignee distribution parameters for the at least one commodity are indicative of, for the at least one commodity, a distribution of at least one of:
a proportion of delayed containers for the at least one consignee,
a ratio of used time extension over granted time extension of shipments for the at least one consignee, and
a ratio of used time extension over available time extension of shipments for the at least one consignee; and
generating the consignee risk factor based on the one or more consignee distribution parameters.

10. The method according to claim 1, wherein the turn time parameter comprises a consignee turn time parameter associated with a consignee of the container.
